(19) United States
(12) Patent Application Publication
(10) Pub. No.: US 2008/0257082 A1
(43) Pub. Date: Oct. 23, 2008

(54) Ball screw with a changeable oil-storage unit

(75) Inventor: Yung-Tsai Chuo, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 12/214,817

(22) Filed: Jun. 23, 2008

Related U.S. Application Data
(63) Continuation-in-part of application No. 11/091,802, filed on Mar. 28, 2005.

(51) Int. Cl. F16H 27/02

(52) U.S. Cl. 74/89.44

(57) ABSTRACT

A ball screw with a changeable oil-storage unit comprises: a screw shaft, a nut mounted on the screw shaft, a plurality of rolling elements, the nut defined with oil filler hole; an oil-storage unit having an oil feeding hole and an oil-storage space; a connector having a through hole and two connecting portions for mating with the oil filler hole of the nut and the oil feeding hole of the oil-storage space, respectively; one of the connecting portions has a tongue and groove arrangement, so that the through hole of the connector is connected to the oil filler hole of the nut and the oil feeding hole of the oil-storage space, forming an oil route that is used to provide lubricating oil for the ball screw.

This application is a continuation of part of U.S. patent application Ser. No. 11/091,802, which claims the benefit of the earlier filing date of Mar. 28, 2005. Claims 1 of this application is new, claim 7 of this application is the combination of the previous claims 1 and 6 of the U.S. patent application Ser. No. 11/091,802, claim 13 of this application is the combination of the previous claims 1 and 4 of the U.S. patent application Ser. No. 11/091,802, claims 2-6, 8-12, and 14-18 of this application correspond to the previous claims 13, 8, 15, 16 and 17 of the U.S. patent application Ser. No. 11/091,802, respectively.

### BACKGROUND OF THE INVENTION

1. Field of the Invention

The present invention relates to a ball screw with a changeable oil-storage unit which enables the oil-storage unit to be assembled to or disassembled away from the screw shaft quickly and easily, thus providing a long lasting self-lubrication function for the ball screw.

2. Description of the Prior Arts

Ball screw is such a machine that is used for motion transmission by taking use of the relative motion between its nut and screw shaft, the movement of the nut is realized by the rolling motion of the rolling elements between the nut and the screw shaft, so that the ball screw has a high efficiency of mechanical transmission. However, if the ball screw has not been lubricated enough for a long period of time, it may result in an increase in friction between the nut and the screw shaft, thus accelerating the abrasion of the ball screw. Hence, self lubricating function of a linear guideway has become more and more important. So far, the self-lubricating methods are generally divided into two types: the first method is to fix the lubricating system at both ends of the nut, lubricating oil is stored in the lubricating system, and then an oil absorbing material is used to smear the lubricating oil to the surface of the screw shaft. Another method is to fix an oil-absorbing material made wiper at either side of the nut, lubricating oil is stored in the oil absorbing material, and the oil absorbing material keeps contacting the surface of the screw shaft, so as to lubricate the teeth of the screw shaft, so that the rolling elements can be lubricated indirectly when rolling through the teeth of the screw shaft.

Both of these two methods are to lubricate the teeth of the screw shaft, and then the rolling elements only can be lubricated indirectly by the lubricating oil left on the screw shaft when rolling through the teeth of the screw shaft, therefore, the rolling elements may not be evenly lubricated, and it will cause waste of lubricating oil. In addition, both of the above-mentioned oil absorbing material and the oil-storage unit only can store a small amount of oil, so the lubrication effect will not last for a long time. However, the service life of the linear guideway is 5-10 years or above, as a result, the rail of the linear guideway will be spoiled ahead of its service life time, due to lack of lubrication. On the other hand, it will be time-consuming and difficult when the oil absorbing material and the oil-storage unit are assembled to or disassembled from the sliding block since they are fixed by screwing method.

The present invention has arisen to mitigate and/or obviate the afore-described disadvantages.

### SUMMARY OF THE INVENTION

The primary objective of the present invention is to provide a ball screw with a changeable oil-storage unit which can lubricate the ball screw automatically for a long period of time. The ball screw comprises screw shaft, nut, oil-storage unit and connector, the screw shaft being a column-shaped structure and provided at its outer surface with a plurality of teeth; a nut mounted on the screw shaft and provided with inner threads for mating with the outer threads of the screw shaft, a plurality of rolling elements rotatably disposed between the inner threads and the outer threads, the nut defined with a circulating unit for permitting the rolling element to circulate endlessly, so as to cause a motion of the nut relative to the screw shaft, on the nut being defined with oil filler hole.

In order to provide a long lasting self-lubrication function for the ball screw and to increase the amount of the lubricating oil stored in the ball screw, an oil-storage unit having oil-storage space and oil feeding hole in communication with the oil-storage space is made initially, and then design a connector having a through hole, at both ends of the through hole being disposed two connecting portions for mating with the oil filler hole of the nut and the oil feeding hole of the oil-storage space, respectively. The through hole of the connector acts as an oil route in communication with the oil filler hole of the nut and the oil feeding hole of the oil-storage unit.

To enable the oil-storage unit to be assembled to or disassembled away from the nut more quickly and easily, one of the connecting portions of the connector is designed to have a tongue and groove arrangement for providing quick connection to the nut, so that the lubricating oil can flow via the previously mentioned oil route to the oil filler hole of the nut, so as to lubricate the rolling elements. Since the oil-storage unit can be easily replaced after the oil is used up, it can provide a long lasting automatic self-lubrication function for the ball screw, and consequently, the service life of the ball screw is prolonged.

To vary the production and the application of the oil-storage unit, the oil-storage space of the oil-storage unit can be a unitary structure or can be made up of a base and a cover, which are jointed together by ultrasonic welding, thermofussion welding, or gluing methods. The connector can be integral with the oil-storage unit, or it can be integral with the nut, so that the oil-storage unit can be fixed to the nut more easily.

The present invention also thinks of the connection structure between the oil-storage unit and the connector, wherein the connecting portion of the connector is a projecting structure, while the oil feeding hole of the oil-storage unit is a concaved structure, or vice verse, so that the oil-storage unit and the connector are connected together in a tongue and groove manner.

For easy replacement of the oil-storage unit, the oil-storage space of the oil-storage unit is made into a close structure in such a manner that an oil feeding hole of the oil-storage unit is sealed with a film, a ball or a spring plug, and the connector is designed to have a knock pin, when the oil-storage unit is engaged with the connector, the knock pin will pierce through the film or push the ball, or the spring plug away, so that the through hole of the connector is in communication with the oil feeding hole of the oil-storage unit, so as to form an oil route. If the connector is integral with the oil-storage unit or with the nut, the film, the spring plug or the ball is sealed at an end of the through hole of the connector for prevention of oil leak before connection. Furthermore, the oil-storage unit can be made of transparent material for enabling the user to check the oil level in the oil-storage and to check if the ball or the spring plug has been pushed away to open the through hole of the connector.

The present invention further thinks of the connection structure between the oil-storage unit and the nut, wherein one of the connecting portions of the connector is designed to have a tongue and groove arrangement for providing quick connection to the nut. For example, the oil-storage unit is defined with hooks, and the nut is provided with locking cavities, or the oil-storage unit is defined with locking cavities, and the nut is provided with hooks, so as to permit the oil-storage unit to be assembled to the nut more easily and quickly. The oil-storage unit is formed correspondingly to the shape of the nut, for example, it can be Π-shaped when the nut is square, or it can be C-shaped or U-shaped when the nut is cylindrical.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a ball screw with a changeable oil-storage unit in accordance with a first preferred embodiment of the present invention;

FIG. 2 shows a ball screw with a changeable oil-storage unit in accordance with a second preferred embodiment of the present invention;

FIG. 3 is an enlarged view of the oil-storage unit on the ball screw of FIG. 2;

FIG. 4A shows a first type of connector of the ball screw in accordance with the present invention;

FIG. 4B shows a second type of connector of the ball screw in accordance with the present invention;

FIG. 4C shows a third type of connector of the ball screw in accordance with the present invention;

FIG. 4D shows a fourth type of connector of the ball screw in accordance with the present invention;

FIG. 5 shows another type of oil-storage unit in accordance with the present invention;

FIG. 6 shows a connector being integral with an oil-storage unit;

FIG. 7A shows a first type of connection manner between the oil-storage unit and the connector in accordance with the present invention;

FIG. 7B shows a second type of connection manner between the oil-storage unit and the connector in accordance with the present invention;

FIG. 7C shows a third type of connection manner between the oil-storage unit and the connector in accordance with the present invention;

FIG. 7D show a fourth type of connection manner between the oil-storage unit and the connector in accordance with the present invention;

FIG. 7E show a fifth type of connection manner between the oil-storage unit and the connector in accordance with the present invention; and

FIG. 7F show a sixth type of connection manner between the oil-storage unit and the connector in accordance with the present invention.

### DETAILED DESCRIPTION OF THE PREFERRED EMBODIMENTS

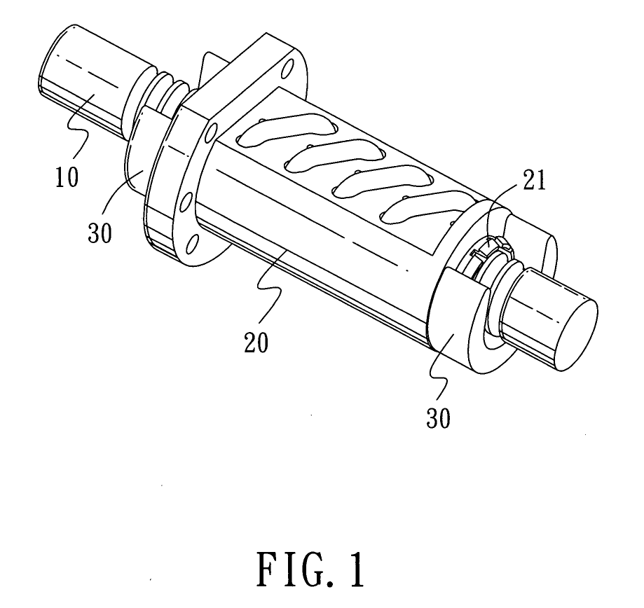

FIG. 1 shows a ball screw with a changeable oil-storage unit in accordance with a first preferred embodiment of the present invention, in which, a screw shaft 10 is a column-shaped member provided at its outer surface with a plurality of teeth. The nut 20 is mounted on the screw shaft 10 and is provided with hooks 21 at both ends thereof for retaining an oil-storage unit 30. The ball screw can be lubricated automatically when the lubricating oil in the oil-storage unit flows to the nut 20. The hooks 21 can be circular-shaped or any other shapes as along as it has a hooking function.

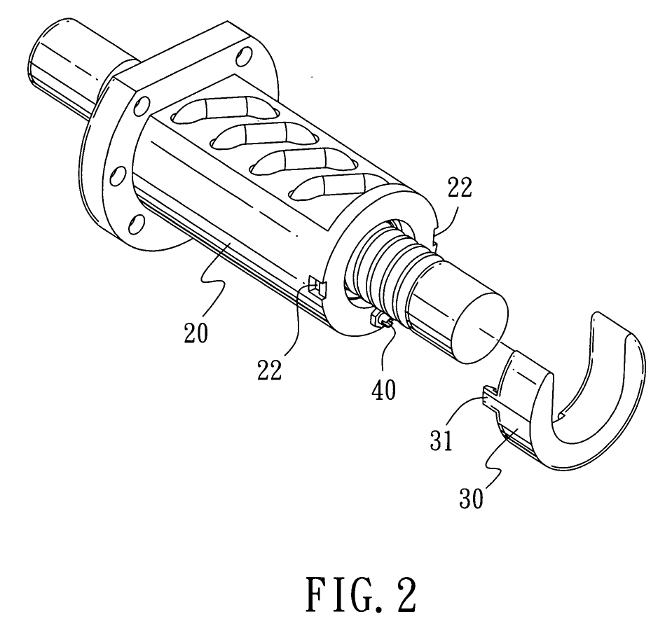

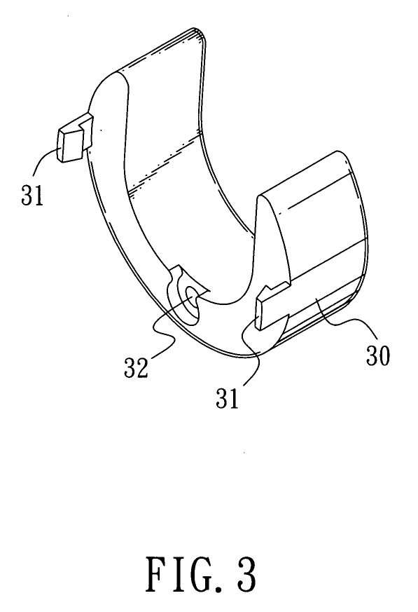

FIG. 2 shows a ball screw with a changeable oil-storage unit in accordance with a second preferred embodiment of the present invention; FIG. 3 is an enlarged view of the oil-storage unit on the ball screw of FIG. 2. The oil-storage unit 30 is U-shaped in response to the shape of the screw shaft 20 and is provided with hooks 31 and an oil feeding hole 32. On the outer surface of the screw shaft 20 are formed locking cavities 22 correspondingly to the hooks 31, and at the oil filler hole (not shown) of the nut 20 is provided a connector 40 for mating with the oil feeding hole 32. By such arrangements, the oil-storage unit 30 can be affixed to the end surface of the nut 20 easily and quickly, and the lubricating oil in the oil-storage unit 30 can flows through the oil feeding hole 32 and the connector 40 into the nut 20, and thus the ball screw can be lubricated automatically.

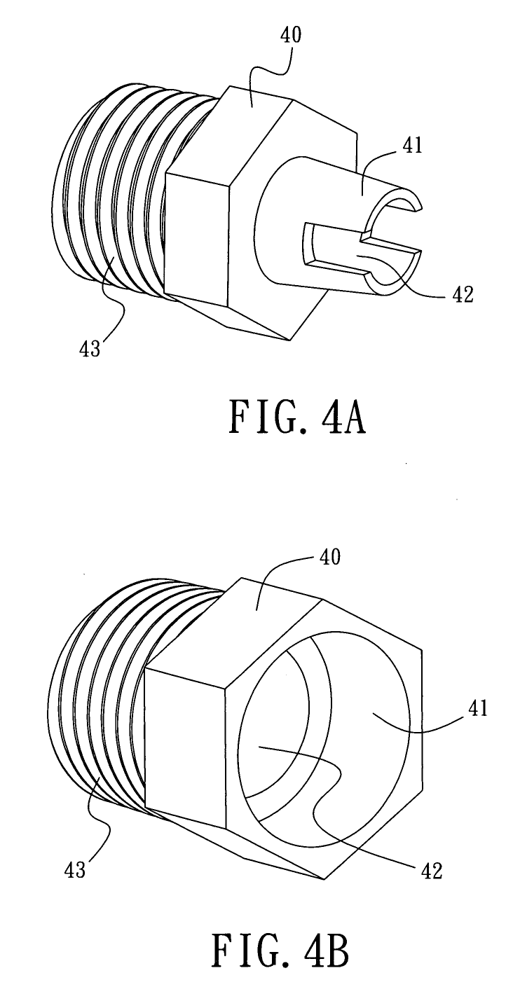

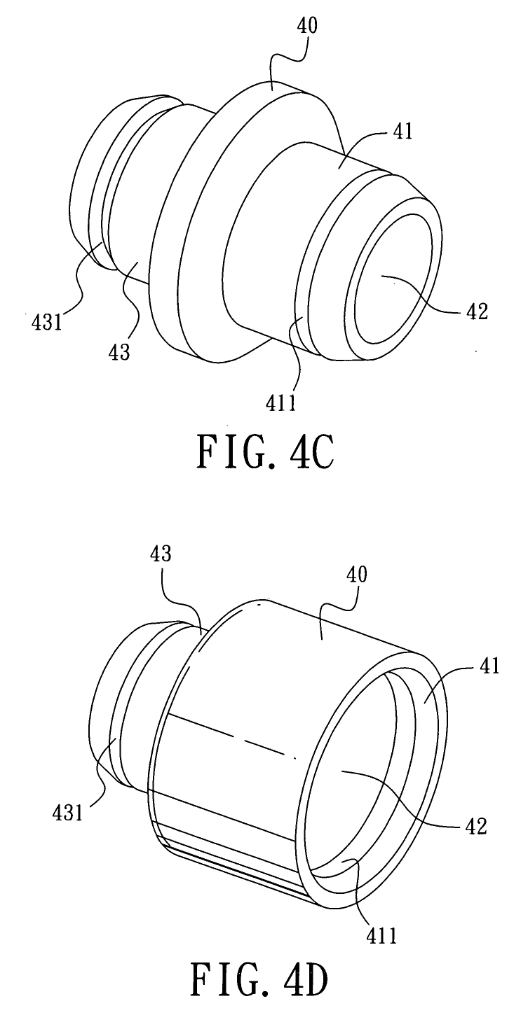

FIGS. 4A-4D show different types of connectors of the ball screw in accordance with the present invention, in which, the connector 40 is interiorly defined with a through hole 42, at both ends of which are formed connecting portions 41, 43, which are connected to the oil filler hole on the nut (not shown) and the oil feeding hole on the oil-storage unit (not shown), respectively. A connecting portion 41 at an end of the connector 40 as shown in FIG. 4A is a projecting structure having a groove that can be connected easily to the nut or the oil-storage unit in a tongue and groove manner, the connecting portion 43 at another end of the connector 40 of FIG. 4A is provided with outer threads. A connecting portion 41 at an end of the connector 40 in FIG. 4B is a concave structure that can be connected easily to the nut or the oil-storage unit in a tongue and groove manner, and the connecting portion is also provided with outer threads. In FIG. 4C, both connecting portions 41, 43 of the connector 40 are projecting structures having a locking groove 411, 431, which are to be connected to the nut or the oil-storage unit in a tongue and groove manner. In FIG. 4D, the connecting portion 43 of the connector 40 is a projecting structure having a locking groove 431, while the connecting portion 41 is a concave structure having a locking groove 411.

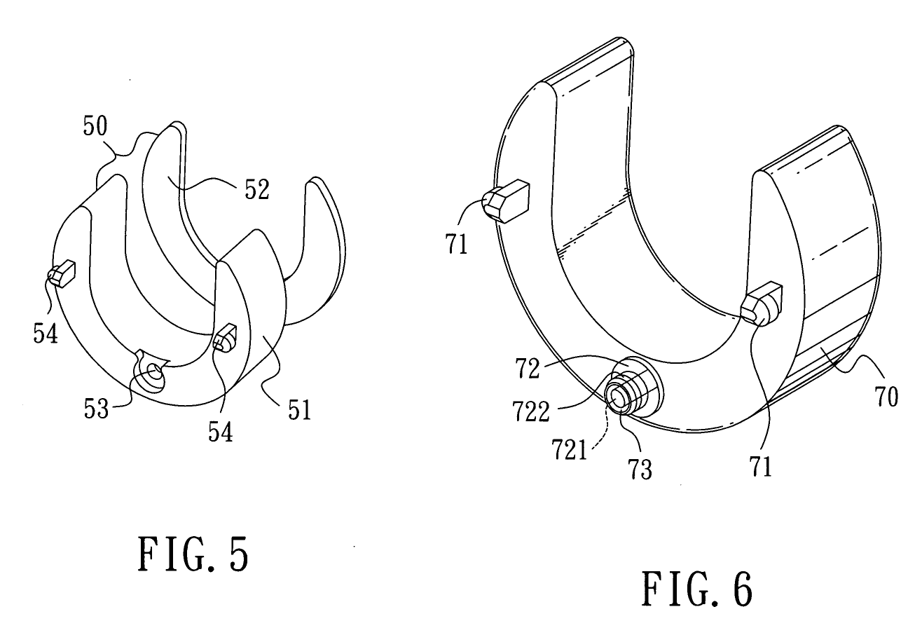

FIG. 5 shows different types of oil-storage unit in accordance with the present invention. The oil-storage unit 50 in FIG. 5 is made up of a base 51 and a cover 52 which are fixed together to form an oil-storage space (not shown). The oil-storage unit 50 is defined with an oil feeding hole 53 in communication with the oil-storage space, and on the oil-storage unit 50 is further formed two symmetrical hooks 54.

FIG. 6 shows a connector being integral with an oil-storage unit, in this embodiment, the oil-storage unit 70 is provided with hooks 71 and connector 72. The oil feeding hole 721 of the connector 72 is a projecting structure which can be connected to the oil route, an end of the oil feeding hole 721 is sealed with a film 73 for prevention of oil leak, and the connecting portion of the oil feeding hole 721 is provided with a tongue and groove arrangement 722 which is to be connected to the nut in a tongue and groove manner.

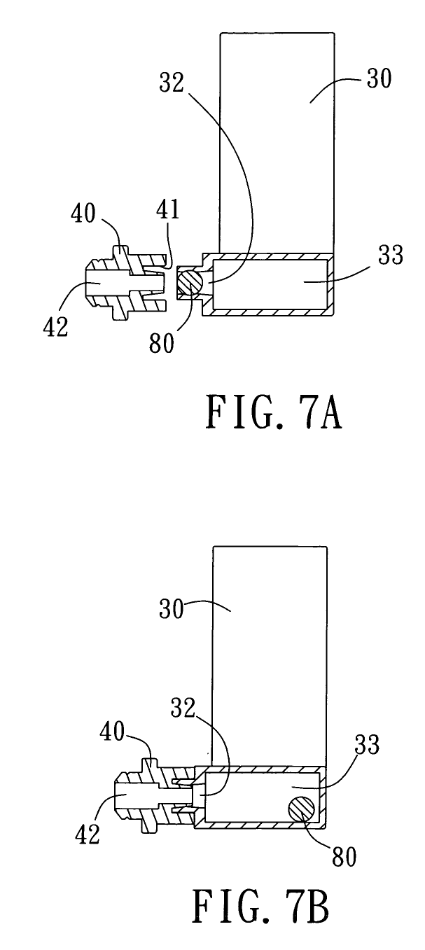

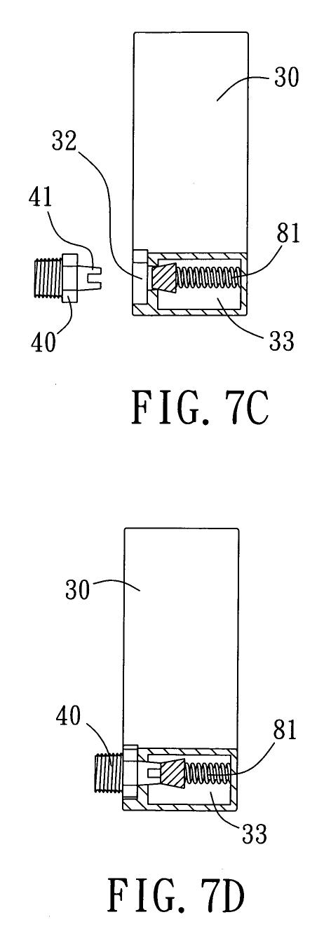

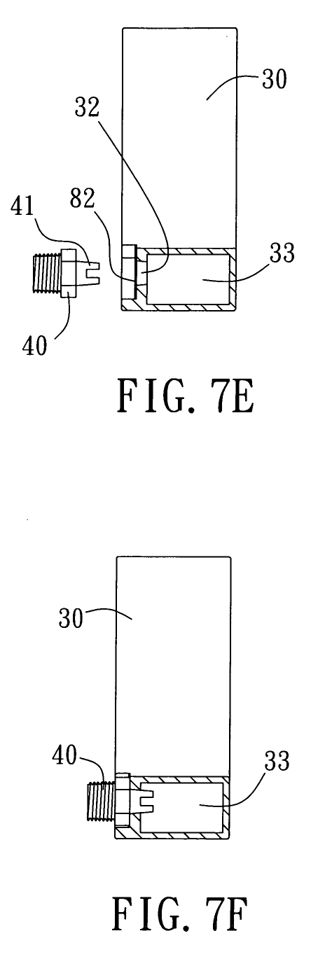

FIGS. 7A-7F show different types of connection manner between the oil-storage unit and the connector in accordance with the present invention. In FIGS. 7A and 7B, the oil feeding hole 32 of the oil-storage unit 30 for connecting the oil-storage space 33 is sealed with a ball 80, and the oil feeding hole 32 of the oil-storage unit 30 is a projecting structure. The connecting portion 41 at an end of the through hole 42 of the connector 40 is a concaved structure having a knock pin that will push the ball 80 away when the oil-storage unit 30 is engaged with the connector 40, so that the oil feeding hole 32 of the oil-storage unit 30 will be in communication with the through hole 42 of the connector 40. In FIGS. 7C and 7D, the oil feeding hole 32 in the oil-storage space 33 of the oil-storage unit 30 is sealed with a spring plug 81, the oil feeding hole 32 of the oil-storage unit 30 is a concave structure, and the connecting portion 41 of the connector 40 is a projecting structure which is formed in the shape of a knock pin, so that the knock pin will push the spring plug 81 away when the oil-storage unit 30 is engaged with the connector 40, so that the oil feeding hole 32 of the oil-storage unit 30 will be in communication with the through hole 42 of the connector 40. In FIGS. 7E and 7F, the oil feeding hole 32 in the oil-storage space 33 of the oil-storage unit 30 is sealed with a film 82, the oil feeding hole 32 of the oil-storage unit 30 is a concave structure, and the connecting portion 41 of the connector 40 is a projecting structure which is formed in the shape of a knock pin, so that the knock pin will pierce through the film 82 when the oil-storage unit 30 is engaged with the connector 40, so that the oil feeding hole 32 of the oil-storage unit 30 will be in communication with the through hole 42 of the connector 40.

While we have shown and described various embodiments in accordance with the present invention, it should be clear to those skilled in the art that further embodiments may be made without departing from the scope of the present invention.

What is claimed is:

1. A ball screw with a changeable oil-storage unit comprising:
a screw shaft being a column-shaped structure and provided at its outer surface with a plurality of teeth;
a nut mounted on the screw shaft and provided with inner threads for mating with outer threads of the screw shaft, a plurality of rolling elements rotatably disposed between the inner threads and the outer threads, the nut defined with a circulating unit for permitting the rolling element to circulate endlessly, so as to cause a motion of the nut relative to the screw shaft, on the nut being defined an oil filler hole;
oil-storage unit having an oil feeding hole and an oil-storage space in communication with the oil feeding hole;
a connector having a through hole, at both ends of the through hole being disposed two connecting portions for mating with the oil filler hole of the nut and the oil feeding hole of the oil-storage space, respectively;
wherein one of the connecting portions has a tongue and groove arrangement so as to provide a quick connection, so that the through hole of the connector is connected to the oil filler hole of the nut and the oil feeding hole of the oil-storage space, forming an oil route that is used to provide lubricating oil for the ball screw, one of the ends of the through hole of the connector is sealed with a spring plug.

2. The ball screw with a changeable oil-storage unit as claimed in claim 1, the oil feeding hole of the oil-storage unit is sealed with the spring plug, the connecting portion of the connector is provided with a knock pin that will push the spring plug away when the oil-storage unit is engaged with the connector, so that the oil feeding hole of the oil-storage unit will be in communication with the through hole of the connector.

3. The ball screw with a changeable oil-storage unit as claimed in claim 1, wherein the connecting portion of the connector is a projecting structure, and the oil feeding hole of the oil-storage unit is a concave structure.

4. The ball screw with a changeable oil-storage unit as claimed in claim 1, wherein the oil storage space of the oil-storage unit is made up of a base and a cover.

5. The ball screw with a changeable oil-storage unit as claimed in claim 1, wherein the oil-storage unit is provided with hooks, and the nut is correspondingly provided with locking cavities.

6. The ball screw with a changeable oil-storage unit as claimed in claim 1, wherein the nut is provided with hooks, and the oil-storage unit is correspondingly provided with locking cavities.

7. A ball screw with a changeable oil-storage unit comprising:
a screw shaft being a column-shaped structure and provided at its outer surface with a plurality of teeth;
a nut mounted on the screw shaft and provided with inner threads for mating with outer threads of the screw shaft, a plurality of rolling elements rotatably disposed between the inner threads and the outer threads, the nut defined with a circulating unit for permitting the rolling element to circulate endlessly, so as to cause a motion of the nut relative to the screw shaft, on the nut being defined an oil filler hole;
oil-storage unit having an oil feeding hole and an oil-storage space in communication with the oil feeding hole;
a connector having a through hole, at both ends of the through hole being disposed two connecting portions for mating with the oil filler hole of the nut and the oil feeding hole of the oil-storage space, respectively;
wherein one of the connecting portions has a tongue and groove arrangement so as to provide a quick connection, so that the through hole of the connector is connected to the oil filler hole of the nut and the oil feeding hole of the oil-storage space, forming an oil route that is used to provide lubricating oil for the ball screw, one of the ends of the through hole of the connector is sealed with a ball.

8. The ball screw with a changeable oil-storage unit as claimed in claim 7, the oil feeding hole of the oil-storage unit is sealed with the ball, the connecting portion of the connector is provided with a knock pin that will push the ball away when the oil-storage unit is engaged with the connector, so that the oil feeding hole of the oil-storage unit will be in communication with the through hole of the connector.

9. The ball screw with a changeable oil-storage unit as claimed in claim 7, wherein the connecting portion of the connector is a projecting structure, and the oil feeding hole of the oil-storage unit is a concave structure.

10. The ball screw with a changeable oil-storage unit as claimed in claim 7, wherein the oil storage space of the oil-storage unit is made up of a base and a cover.

11. The ball screw with a changeable oil-storage unit as claimed in claim 7, wherein the oil-storage unit is provided with hooks, and the nut is correspondingly provided with locking cavities.

12. The ball screw with a changeable oil-storage unit as claimed in claim 7, wherein the nut is provided with hooks, and the oil-storage unit is correspondingly provided with locking cavities.

13. A ball screw with a changeable oil-storage unit comprising:
a screw shaft being a column-shaped structure and provided at its outer surface with a plurality of teeth;
a nut mounted on the screw shaft and provided with inner threads for mating with outer threads of the screw shaft, a plurality of rolling elements rotatably disposed between the inner threads and the outer threads, the nut defined with a circulating unit for permitting the rolling element to circulate endlessly, so as to cause a motion of the nut relative to the screw shaft, on the nut being defined an oil filler hole;
oil-storage unit having an oil feeding hole and an oil-storage space in communication with the oil feeding hole;
a connector having a through hole, at both ends of the through hole being disposed two connecting portions for mating with the oil filler hole of the nut and the oil feeding hole of the oil-storage space, respectively;
wherein one of the connecting portions has a tongue and groove arrangement so as to provide a quick connection, so that the through hole of the connector is connected to the oil filler hole of the nut and the oil feeding hole of the oil-storage space, forming an oil route that is used to provide lubricating oil for the ball screw, one of the ends of the through hole of the connector is sealed with a film.

14. The ball screw with a changeable oil-storage unit as claimed in claim 13, the oil feeding hole of the oil-storage unit is sealed with the film, the connecting portion of the connector is provided with a knock pin that will pierce through the film when the oil-storage unit is engaged with the connector, so that the oil feeding hole of the oil-storage unit will be in communication with the through hole of the connector.

15. The ball screw with a changeable oil-storage unit as claimed in claim 13, wherein the connecting portion of the connector is a projecting structure, and the oil feeding hole of the oil-storage unit is a concave structure.

16. The ball screw with a changeable oil-storage unit as claimed in claim 13, wherein the oil storage space of the oil-storage unit is made up of a base and a cover.

17. The ball screw with a changeable oil-storage unit as claimed in claim 13, wherein the oil-storage unit is provided with hooks, and the nut is correspondingly provided with locking cavities.

18. The ball screw with a changeable oil-storage unit as claimed in claim 13, wherein the nut is provided with hooks, and the oil-storage unit is correspondingly provided with locking cavities.
